(19) United States
(12) Patent Application Publication
(10) Pub. No.: US 2018/0197129 A1
(43) Pub. Date: Jul. 12, 2018

(54) DETECTING VULNERABILITIES IN A SUPPLY CHAIN

(71) Applicant: International Business Machines Corporation, Armonk, NY (US)

(72) Inventors: Ana Paula APPEL, Sao Paulo (BR); Ricardo Vieira Borges FRANCO, Sao Paulo (BR); Marisa Affonso VASCONCELOS, Sao Paulo (BR)

(21) Appl. No.: 15/401,222

(22) Filed: Jan. 9, 2017

(51) Int. Cl. G06Q 10/06

(52) U.S. Cl. CPC G06Q 10/06315

(57) ABSTRACT

Vulnerabilities in a supply chain are detected by creating a graphical representation of the supply chain containing a plurality of nodes and a plurality of edges between nodes. Each node is an entity in the supply chain, and each entity has an associated profile of properties for that entity. Each edge represents an interaction between two entities. The set of descriptive properties at each entity in the supply chain and each interaction between two entities are used to determine a current level of vulnerability to perturbations in the supply chain for a plurality of entities in the supply chain. Remedial actions to be taken in the supply chain can then be identified to reduce the current level of vulnerability for at least one entity in the supply chain.

### FIELD OF THE INVENTION

The present invention relates to supply chain management.

### BACKGROUND OF THE INVENTION

Existing supply chains are complex networks that involve the relationship among multiple entities including consumers, business, and banks. Assessing risks or weakness in each one of the supply chain entities is not trivial, since the relationships among the entities are not a simple one-to-one relationships. Any disruption in the supply chain can cause revenue losses across two or more entities. Therefore, these relationships need to be considered in accessing risk in supply chains.

### SUMMARY OF THE INVENTION

Exemplary embodiments are directed to using a more complex view of supply chains to capture explicit and implicit aspects of the relationship between customers and business to estimate credit costs accurately. Methods and systems are provided to assess credit risk through a network built using Business to Business (B2B) and Consumer to Business (C2B) and Business to Consumer (B2C) data. A system takes into account all of the entities and interactions in a supply chain to determine the vulnerabilities, e.g., creditworthiness, of one or more entities in the supply chain. These vulnerabilities can indicate, for example, if a given entity will honor financial commitments with suppliers or if the entity will receive all necessary financial commitments for a project or expansion. These vulnerabilities can be used to determine and enact remedial measures. For example, a bank may improve the financial health of one of the entities by offering a preemptive line or credit or loan to improve or provide cash. In addition to the financial health of entities, other properties of the entities are considered such as centrality, shortest-path, community detection and small-world properties to determine the importance of each entity in the chain.

A supply chain network is built connecting entities such as banks, consumers and businesses using information such as financial information (bank transactions), web-based information and company generated information (annual reports). The resulting network has temporal properties, i.e., the nodes and edges may change over time. Vulnerabilities such as credit risk indexes are computed using the network to detect entities that are vulnerable, e.g., represent a high credit risk. Another entity, such as a bank, can use that score to predict possible vulnerabilities and take preemptive remedial measures.

Exemplary embodiments are directed to a method for detecting vulnerabilities in a supply chain. A graphical representation of the supply chain is created. This graphical representation includes a plurality of nodes and a plurality of edges between nodes. Each node is an entity in the supply chain. In one embodiment, each entity is a business, a financial institution, an insurance provider, an aggregate of customers, a vendor, a licensing agency or a regulatory agency. Each entity has a profile. In one embodiment, each profile includes at least one of geographical location, number of employees, demographic data, revenue, credit score, popularity, capitalization, current liabilities, licenses, real property, personal property, history of business transactions, corporate structure and industrial sector.

Each edge is an interaction between two entities. In one embodiment, the interactions between entities include an exchange of goods or services, a loan, a contract, a payment, a supply of materials, an extension of credit, a regulatory control, a license, a legal proceeding and combinations thereof. The profile at each entity in the supply chain and each interaction between two entities are used to determine a current level of vulnerability to perturbations in the supply chain for a plurality of entities in the supply chain. In one embodiment, external data are used in combination with the profile at each entity in the supply chain and each transaction between two entities to determine the current level of vulnerability to perturbations in the supply chain for the plurality of entities in the supply chain. Suitable external data include, but are not limited to, meteorological data, economic data, geopolitical data, commodity market data, business market data and demographic trends data. The current level of vulnerability to perturbations in the supply chain can include current cash flow, current creditworthiness, current capital reserves, current market share, current availability of raw materials, current backlog, current ability to meet demand, insufficient insurance, current regulatory constraint and combinations thereof.

Remedial actions to be taken in the supply chain to reduce the current level of vulnerability for at least one entity in the supply chain are identified. Suitable remedial actions include, but are not limited to, extending credit, making a loan, identifying alternative sources of raw materials, providing access to working capital, identifying investors, increasing insurance, granting a regulatory waiver and combinations thereof. In one embodiment, the method also includes enacting the remedial actions in the supply chain. In addition, the profile for at least one entity in the graphical representation is updated based on the remedial actions enacted in the supply chain. In one embodiment, a number of levels through the nodes of the graphical representation of the supply chain to receive an updated profile following enacting of remedial actions in the supply chain is identified, and the profiles for all nodes within the number of levels from the at least one entity in the supply chain for which the remedial actions were enacted to reduce the current level of vulnerability are updated.

In one embodiment, the nodes and edges in the graphical representation of the supply chain are filtered in accordance with common elements in the profiles. Therefore, only portions of the graphical representation are displayed or highlighted. In one embodiment, the graphical representation of the supply chain is displayed in a graphical user interface, for example, on a computer, and the graphical user interface is used to highlight at least one of nodes having common elements in the profiles, nodes having current levels of vulnerability above of predetermined vulnerability level and nodes having current levels of vulnerability within a threshold variance from the predetermined vulnerability level.

Exemplary embodiments are also directed to a computing system for detecting vulnerabilities in a supply chain. This computing system includes a database storing a plurality of entities in the supply chain, a profile for each entity and a plurality of interactions between pairs of entities. In addition, a graph builder is provided in communication with the database to create a graphical representation of the supply chain. This graphical representation includes a plurality of nodes and a plurality of edges between nodes. Each node is one of the plurality of entities, and each edge is one of the plurality of interactions. A prediction module is in communication with the database and the graph builder to determine a current level of vulnerability to perturbations in the supply chain for a plurality of entities in the supply chain using the set of descriptive properties at each entity in the supply chain and each interaction between two entities. In addition, a recommendation module is in communication with the prediction module to identify remedial actions to be taken in the supply chain to reduce the current level of vulnerability for at least one entity in the supply chain.

In one embodiment, each entity is a business, a financial institution, an insurance provider, an aggregate of customers, a vendor, a licensing agency or a regulatory agency, and each profile contains at least one of geographical location, number of employees, demographic data, revenue, credit score, popularity, capitalization, current liabilities, licenses, real property, personal property, history of business transactions, corporate structure and industrial sector. In addition, the interactions between entities include an exchange of goods or services, a loan, a contract, a payment, a supply of materials, an extension of credit, a regulatory control, a license, a legal proceeding and combinations thereof, and the current level of vulnerability to perturbations in the supply chain can be current cash flow, current creditworthiness, current capital reserves, current market share, current availability of raw materials, current backlog, current ability to meet demand, insufficient insurance, current regulatory constraint and combinations thereof. Suitable remedial actions include, but are not limited to, extending credit, making a loan, identifying alternative sources of raw materials, providing access to working capital, identifying investors, increasing insurance, granting a regulatory waiver and combinations thereof.

In one embodiment, the computing system also includes an input module in communication with the database to obtain the plurality of entities in the supply chain, the profile for each entity, the plurality of interactions between pairs of entities and external data. These external data include meteorological data, economic data, geopolitical data, commodity market data, business market data and demographic trends data. The prediction module uses the external data in combination with the profile at each entity in the supply chain and each transaction between two entities to determine the current level of vulnerability to perturbations in the supply chain for the plurality of entities in the supply chain. In one embodiment, a remediation module is used to enact the remedial actions in the supply chain, and a profile updater updates the profile for at least one entity based on the remedial actions enacted in the supply chain. In one embodiment, the computing system includes an output module to display the graphical representation of the supply chain in a graphical user interface, and a filter to filter the nodes and edges in the graphical representation of the supply chain in accordance with common elements in the profiles. A plurality of selectable graphics in the graphical user interface are provided to filter the nodes and edges in accordance with an identified set of common elements and to highlight at least one of nodes having current levels of vulnerability above of predetermined vulnerability level and nodes having current levels of vulnerability within a threshold variance from the predetermined vulnerability level.

### BRIEF DESCRIPTION OF THE DRAWINGS

FIG. 1 is an embodiment of a graphical representation of a supply chain;

FIG. 2 is a schematic representation of an embodiment of a computing system for detecting vulnerabilities in a supply chain;

FIG. 3 is a representation of a graphical user interface for displaying a graphical representation of a supply chain;

FIG. 4 is a flow chart illustrating an embodiment of a method for detecting vulnerabilities in a supply chain;

FIG. 5 depicts a cloud computing environment according to an embodiment of the present invention; and

FIG. 6 depicts abstraction model layers according to an embodiment of the present invention.

### DETAILED DESCRIPTION

Exemplary embodiments utilize a more complex view of supply chains to capture explicit and implicit aspects of the relationship between and among the various entities in a supply chain such as customers and businesses to estimate the vulnerabilities in the supply chain and to determine remedial actions to be taken in the supply chain to alleviate these vulnerabilities, e.g., determining the cost of credit. A database of containing information about the entities in the supply chain and the interactions among these entities is created and maintained. This information can be obtained from any available source include social media, banking transaction history, crediting history, entity supplied information, current credit rating from a third party credit rating service, news articles and annual reports. The information maintained in the database is used to create a temporal directed network or graph containing all of the entities in the supply chain, the interactions between pairs of entities. A given node within the graph represents an entity, and the edges between the nodes represent interactions between pairs of entities, e.g., a transaction such as a banking transaction between two entities.

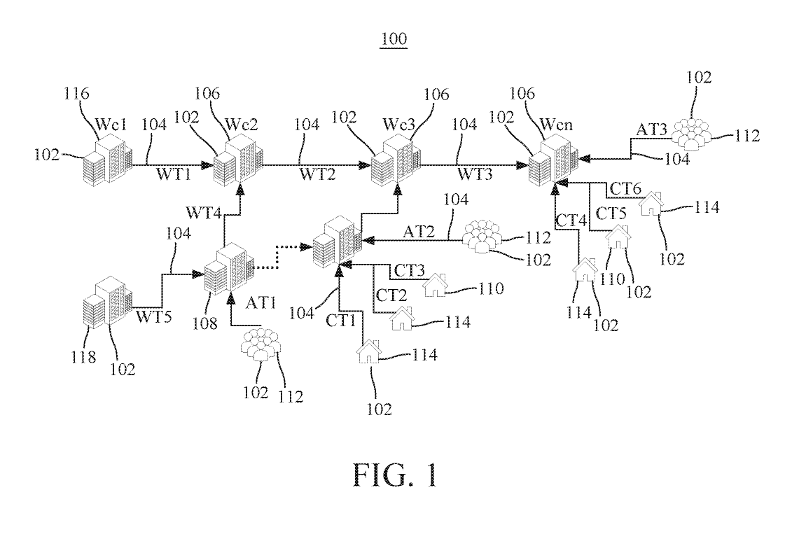

Referring to FIG. 1, an exemplary embodiment of a graphical representation 100 of the supply chain is illustrated. The graphical representation includes a plurality of nodes 102, which can have an associated nodes weight (WcN) that expresses an analysis of the entity, stock price, news about the entity or price in the market, and a plurality of edges 104, which can have weights that can be amount of money flow between two nodes, frequency—monthly or not, etc. (At=WT=Ct), between pairs of nodes in the graph. Each node represents an entity in the supply chain. Suitable entities include, but are not limited to, a business 106, a financial institution 108, an insurance provider 110, an aggregate of customers 112, a vendor 114, i.e., a supplier of materials and services to one or more businesses, a licensing agency 116 or a regulatory agency 118. In one embodiment, the customers are used only to show that businesses receive revenue from customers; therefore, customers are represented in aggregate. Each entity in the graphical representation has associated profile, which is stored in the database and can be viewed by selecting the entity in a graphical environment. The profile contains properties of the entity that can be used in determining the vulnerabilities in the supply chain. In one embodiment, each profile includes at least one of geographical location, number of employees, demographic data, revenue, credit score, popularity, capitalization, current liabilities, licenses, real property, personal property, history of business transactions, corporate structure and industrial sector.

Each edge represents a given interaction, relationship or business transaction between two entities. Suitable interactions between entities include, but are not limited to, an exchange of goods or services, a loan, a contract, a payment, a supply of materials, an extension of credit, a regulatory control, a license, a legal proceeding and combinations thereof. With all of the entities and interactions displayed in the graphical representation, the profile at each entity in the supply chain and each interaction between two entities to determine a current level of vulnerability to perturbations in the supply chain for at least one and preferably a plurality of entities in the supply chain. Therefore, all of the entities in the supply chain and all interactions between the entities are considered in determining, locating or predicting current and future vulnerabilities. Suitable current levels of vulnerability to perturbations in the supply chain include, but are not limited to, current cash flow, current creditworthiness, current capital reserves, current market share, current availability of raw materials, current backlog, current ability to meet demand, insufficient insurance, current regulatory constraint or combinations thereof. These current levels of vulnerability derived from the entire supply chain are then used to determine remedial actions that can be taken to avoid negative consequences or to improve the current level of vulnerabilities. Suitable remedial actions include, but are not limited to, extending credit, making a loan, identifying alternative sources of raw materials, providing access to working capital, identifying investors, increasing insurance, granting a regulatory waiver and combinations thereof.

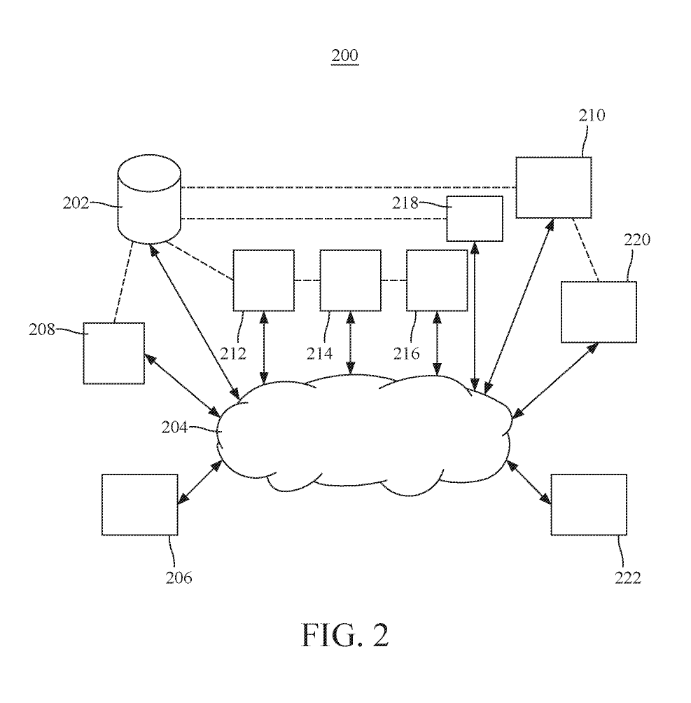

Referring now to FIG. 2, exemplary embodiments are directed to a system such as a computing system for detecting vulnerabilities in a supply chain 200. Suitable computing systems include distributed computing systems and cloud based computing systems. The computing system includes at least one memory 202 such as a hardware memory containing one or more databases including an advertising content database. The databases can also include the software for configuring the computing system, for performing the methods for detecting vulnerabilities in a supply chain and for creating instances of the various systems and modules of the computing system. The computing system includes at least one computer processor 206 that is in communication with the databases or memory and that can execute the software and perform all of the computational functions for operation of the computing system and for detecting vulnerabilities in a supply chain. In one embodiment, the computing system includes a plurality of processors. All of the components, modules and systems of the computing system, including the database and the processor are in communication through one or more local or wide area networks 204.

In one embodiment, the database stores the plurality of entities in the supply chain, the profile for each entity and the plurality of interactions between pairs of entities. Therefore, the database includes all of the information and data necessary to create the graphical representation of the supply chain and to identify vulnerabilities within the supply chain. In order to obtain the information stored in the database, the computing system includes an input module 208 in communication with the database. The input module is also in communication through the networks with all of the sources of information on the plurality of entities in the supply chain, the profile for each entity and the plurality of interactions between pairs of entities. Suitable entities include, but are not limited to, a business, a financial institution, an insurance provider, an aggregate of customers, a vendor, a licensing agency or a regulatory agency. Suitable profile information includes, but is not limited to, geographical location, number of employees, demographic data, revenue, credit score, popularity, capitalization, current liabilities, licenses, real property, personal property, history of business transactions, corporate structure and industrial sector. The interactions between entities represent, for example, an exchange of goods or services, a loan, a contract, a payment, a supply of materials, an extension of credit, a regulatory control, a license, a legal proceeding and combinations thereof.

The input module obtains the desired entity, profile and interaction information from a plurality of sources including, credit reporting agencies, bank records, social media, websites, annual reports and new reports. In one embodiment, the input module also obtains external data, i.e., data external to and not directly influenced by the supply chain. These external data, however, can have an influence on the vulnerabilities of the entities in the supply chain. Suitable external data include, but are not limited to meteorological data, economic data, geopolitical data, commodity market data, business market data and demographic trends data.

The computing system includes a graph builder 210 in communication with the database. The graph builder uses the stored information on the entities, profiles and interactions to create a graphical representation of the supply chain as illustrated, for example, in FIG. 1. In general, the graphical representation contains a plurality of nodes and a plurality of edges between nodes. Each node represents one of the plurality of entities, and each edge is of the plurality of interactions.

The computing system includes a prediction module 212 in communication with the database and the graph builder to determine a current level of vulnerability to perturbations in the supply chain for at least one and alternatively a plurality of entities in the supply chain. This determination of the current level of vulnerability is made using the set of descriptive properties at each entity in the supply chain and each interaction between two entities. In one embodiment, the prediction module also uses the external data in combination with the profile at each entity in the supply chain and each transaction between two entities to determine the current level of vulnerability to perturbations in the supply chain for one or more of the entities in the supply chain. The current level of vulnerability to perturbations in the supply chain include, but are not limited to, a current cash flow, current creditworthiness, current capital reserves, current market share, current availability of raw materials, current backlog, current ability to meet demand, insufficient insurance, current regulatory constraint and combinations thereof.

The computing system includes a recommendation module 214 in communication with the prediction module to identify remedial actions to be taken in the supply chain to reduce the current level of vulnerability for at least one entity in the supply chain. Suitable remedial actions include, but are not limited to, extending credit, making a loan, identifying alternative sources of raw materials, providing access to working capital, identifying investors, increasing insurance, granting a regulatory waiver and combinations thereof. A remediation module 216 is provided in the computing system in communication with the to enact the remedial actions in the supply chain. Having taken the desired remedial actions, a profile updater 218 in the computing system in communication with the database and the input module is used to update the profile for at least one entity based on the remedial actions enacted in the supply chain.

The computing system includes an output module 220 that is in communication with the graph builder 210 to display and to output the graphical representation of the supply chain in a graphical user interface. Manipulation and customization of the graphical user interface of the graphical representation of the supply chain is facilitated by a filter 222 provided in the computing system. The filter is used to filter the nodes and edges in the graphical representation of the supply chain in accordance with common elements in the profiles. The filter can also be configured to provide highlighting or other automatic or user-defined indications in the graphical representation.

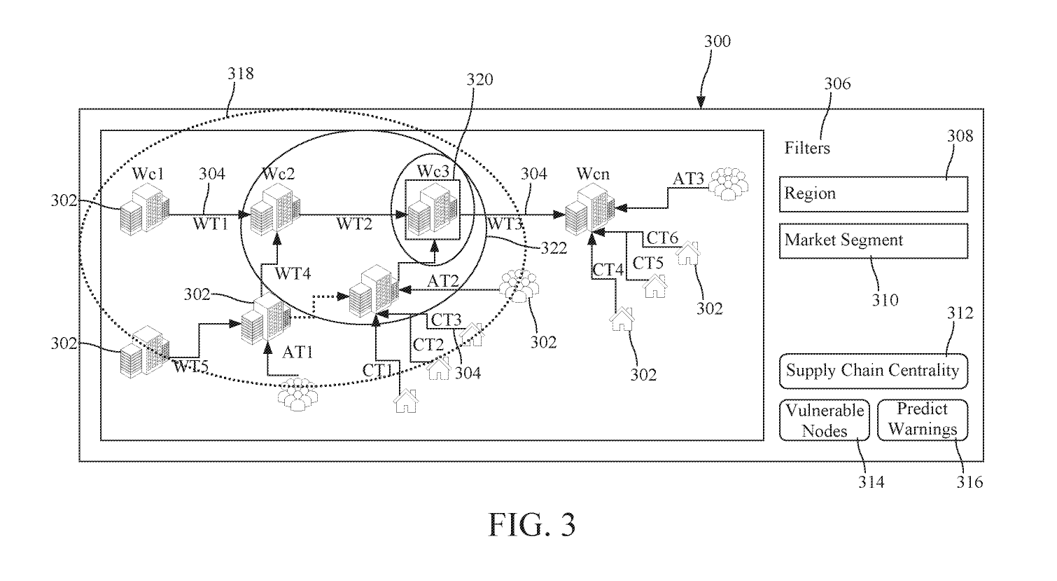

Referring now to FIG. 3, an embodiment graphical user interface 300 used to display the graphical representation 302 of the supply chain is illustrated. The graphical representation includes all of the nodes 304 and all of the edges 304 between the nodes as discussed herein. The graphical user interface also includes a plurality of selectable graphics. For example, all of the nodes and edges can be selected using any suitable device for selecting graphics in a graphical environment. Selecting the nodes and edges can provide information in the identity of the entity or interaction as well as information on the current and historical contents of the profile and any current or previous vulnerabilities associated with the entities. The graphical user interface also includes selectable graphics to filter the nodes and edges 306 in accordance with an identified set of common elements. For example, a selectable button can highlight entities associated with a given geographical region 308 or market segment 310. In addition to highlighting, the entities not included in the selected filter can be removed from the graphical representation. A selectable graphic can be provided to highlight entities that are central 312 to the supply chain, to nodes having current levels of vulnerability above of predetermined vulnerability level 314 or nodes having current levels of vulnerability within a threshold variance from the predetermined vulnerability level 316.

Actual indication of the selected filtering and highlighting criteria can be provide using highlighting, contrasting colors in a node or edge, graphics such as exclamation points in proximity to vulnerable entities, boxes 320 around vulnerable entities, circles or other shapes 318, 320 about entities in a common market or common geographical area. The shapes can also be drawn in the graphical under interface environment to indicate entities that are to be treat as group or to indicate a level or depth within the graph that changes to one of the entities through enactment of remediation measures is to be propagated to change the profiles of other entities.

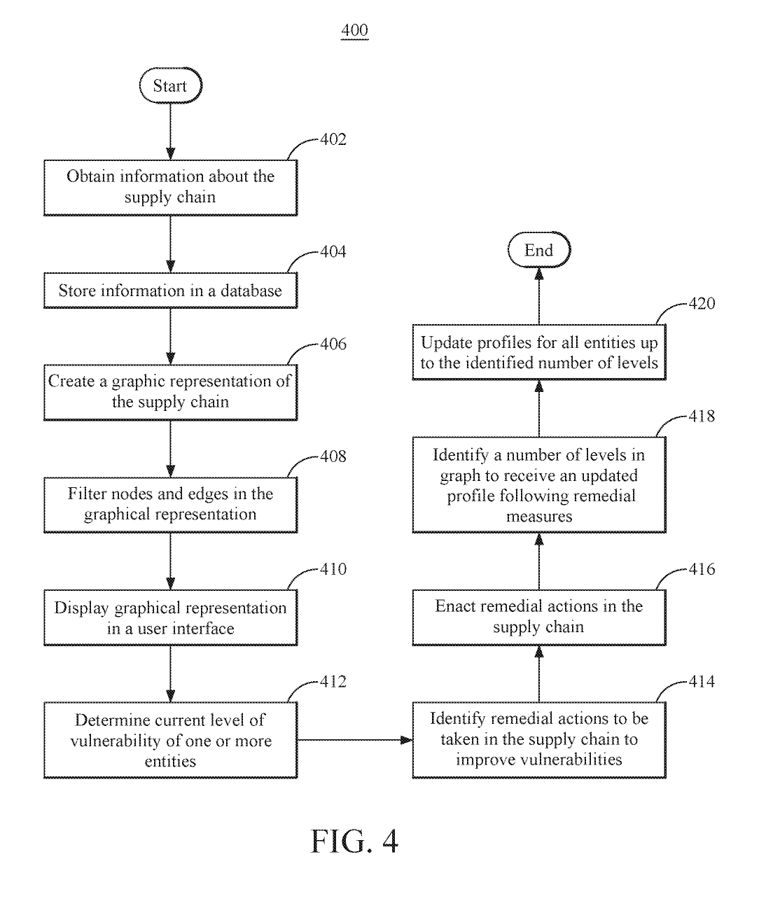

Referring now to FIG. 4, exemplary embodiments are directed to a method for detecting vulnerabilities in a supply chain 400. Information about a desired or identified supply chain is obtained 402. The supply chain can cover a given geographical area, a given country or a given market, among other factors. The obtained information includes an identification of all of the entities in the supply chain, a profile for each entity and an identification of interactions between pairs of entities in the supply chain. All of this information can be obtained from any suitable source as described herein. In addition, suitable entities, profile contents and interactions between pairs of entities are described herein. In one embodiment, additional data external to the supply chain are also obtained. The obtained information is stored in one or more databases 404 and can be updated or modified over time. Therefore, any data including external data can continue to be obtained over time.

A graphical representation of the supply chain is created 406 using the supply chain information stored in the database. The graphical representation includes a plurality of nodes and a plurality of edges between nodes in a temporal graph, i.e., a graph that can change over time as the supply chain changes. Each node is an entity in the supply chain, and each entity has an associated profile. In addition, each edge between nodes represents an interaction, e.g, a business transaction, between two entities. In one embodiment, the nodes and edges in the graphical representation of the supply chain are filtered 408 in accordance with common elements in the profiles. In addition, the graphical representation of the supply chain can be displayed or output in a graphical user interface 410.

The profile of each entity in the supply chain and each interaction between two entities are used to determine a current level of vulnerability to perturbations in the supply chain for a plurality of entities in the supply chain 412. In one embodiment, the obtained external data are also used in combination with the profile at each entity in the supply chain and each transaction between two entities to determine the current level of vulnerability to perturbations in the supply chain for the plurality of entities in the supply chain. Suitable external data for use in determining vulnerabilities include, but are not limited to, meteorological data, economic data, geopolitical data, commodity market data, business market data and demographic trends data. The current level of vulnerability to perturbations in the supply chain represents current cash flow, current creditworthiness, current capital reserves, current market share, current availability of raw materials, current backlog, current ability to meet demand, insufficient insurance, current regulatory constraint and combinations thereof. In one embodiment, the graphical user interface is used to highlight nodes having common elements in the profiles, nodes having current levels of vulnerability above of predetermined vulnerability level or nodes having current levels of vulnerability within a threshold variance from the predetermined vulnerability level.

Remedial actions to be taken in the supply chain are identified 414 in order to reduce the current level of vulnerability for at least one entity in the supply chain. Suitable remedial actions include, but are not limited to, extending credit, making a loan, identifying alternative sources of raw materials, providing access to working capital, identifying investors, increasing insurance, granting a regulatory waiver or combinations thereof. These remedial actions can be applied to one or more entities within the supply chain. The identified remedial actions, either in whole or in part, are enacted in the supply chain 416.

Enacting the remedial measures will affect multiple entities and the profiles of multiple entities in the supply chain. However, the effects of these changes may be attenuated based on the distance, i.e., distance within the graph or supply chain, from the location of the change. Therefore, a number of levels, n, through the nodes of the graphical representation of the supply chain to receive an updated profile following enacting of remedial actions in the supply chain is identified 418. The profile for at least one entity based on the remedial actions enacted in the supply chain, and preferably, the profiles for all nodes within the number of levels from the at least one entity in the supply chain for which the remedial actions were enacted to reduce the current level of vulnerability are updated 420.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to apparatus (systems) and computer program products according to embodiments of the invention. It will be understood that each description and illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram block or blocks.

The schematic illustrations and block diagrams in the Figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

It is to be understood that although a detailed description on cloud computing is provided, implementation of the teachings provided herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service.

This cloud model may include at least five characteristics, at least three service models, and at least four deployment models. The five characteristics are on-demand self-service, broad network access, resource pooling, rapid elasticity and measured service. Regarding on-demand self-service, a cloud consumer can unilaterally provision computing capabilities, such as server time and network storage, as needed automatically without requiring human interaction with the service's provider. Broad network access refers to capabilities that are available over a network and accessed through standard mechanisms that promote use by heterogeneous thin or thick client platforms, e.g., mobile phones, laptops, and PDAs. For resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction, e.g., country, state, or datacenter. Rapid elasticity refers to capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. For measured service, cloud systems automatically control and optimize resource use by leveraging a metering capability at some level of abstraction appropriate to the type of service, e.g., storage, processing, bandwidth, and active user accounts. Resource usage can be monitored, controlled, and reported, providing transparency for both the provider and consumer of the utilized service.

The three service models are Software as a Service (SaaS), Platform as a Service (PaaS) and Infrastructure as a Service (IaaS). Software as a service provides the capability to the consumer to use the provider's applications running on a cloud infrastructure. The applications are accessible from various client devices through a thin client interface such as a web browser, e.g., web-based e-mail. The consumer does not manage or control the underlying cloud infrastructure including network, servers, operating systems, storage, or even individual application capabilities, with the possible exception of limited user-specific application configuration settings. Platform as a service provides the capability to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service provides the capability to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components, e.g., host firewalls.

The Deployment Models are private cloud, community cloud, public cloud and hybrid cloud. The private cloud infrastructure is operated solely for an organization. It may be managed by the organization or a third party and may exist on-premises or off-premises. The community cloud infrastructure is shared by several organizations and supports a specific community that has shared concerns, e.g., mission, security requirements, policy, and compliance considerations. It may be managed by the organizations or a third party and may exist on-premises or off-premises. The public cloud infrastructure is made available to the general public or a large industry group and is owned by an organization selling cloud services. The hybrid cloud infrastructure is a composition of two or more clouds (private, community, or public) that remain unique entities but are bound together by standardized or proprietary technology that enables data and application portability, e.g., cloud bursting for load-balancing between clouds.

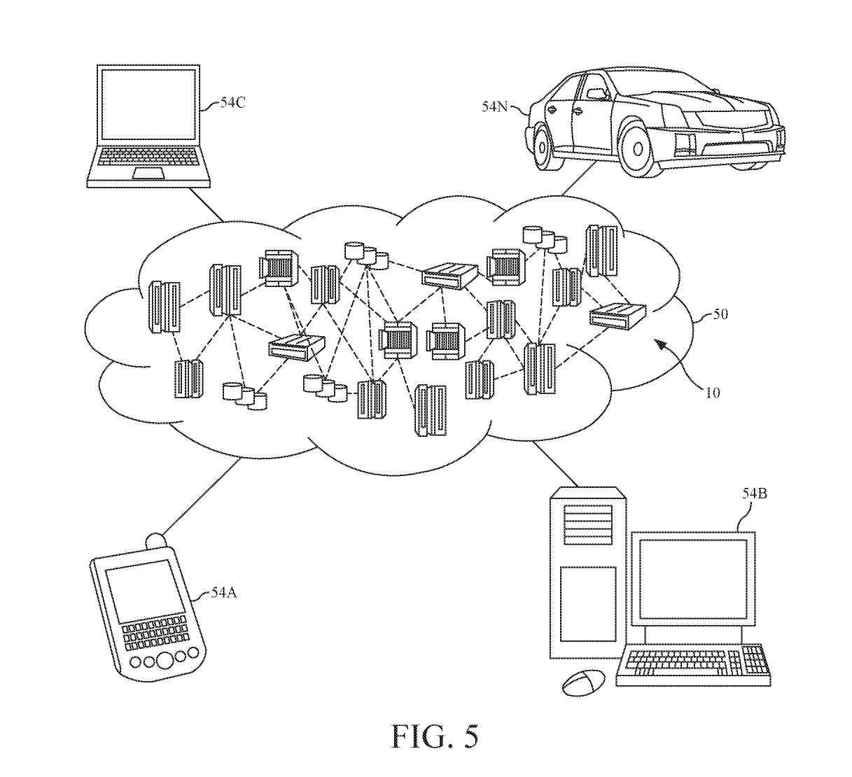

A cloud computing environment is service oriented with a focus on statelessness, low coupling, modularity, and semantic interoperability. At the heart of cloud computing is an infrastructure that includes a network of interconnected nodes. Referring now to FIG. 5, an illustrative cloud computing environment 50 is depicted. As shown, the cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection, e.g., using a web browser.

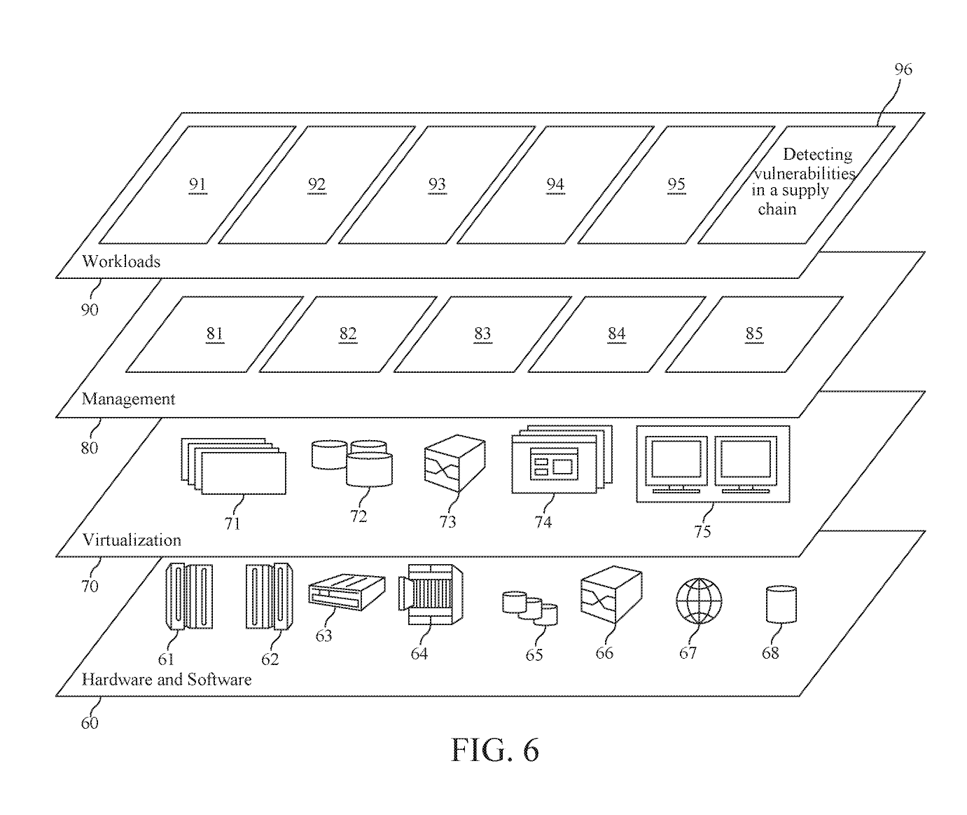

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided. A hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. A virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and detecting vulnerabilities in a supply chain 96.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for detecting vulnerabilities in a supply chain in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for detecting vulnerabilities in a supply chain, the method comprising:
creating a graphical representation of the supply chain, the graphical representation comprising a plurality of nodes and a plurality of edges between nodes, each node comprising an entity in the supply chain, each entity comprising a profile and each edge comprising an interaction between two entities;
using the profile at each entity in the supply chain and each interaction between two entities to determine a current level of vulnerability to perturbations in the supply chain for a plurality of entities in the supply chain; and
identifying remedial actions to be taken in the supply chain to reduce the current level of vulnerability for at least one entity in the supply chain.

2. The method of claim 1, wherein each entity comprises a business, a financial institution, an insurance provider, an aggregate of customers, a vendor, a licensing agency or a regulatory agency.

3. The method of claim 1, wherein each profile comprises at least one of geographical location, number of employees, demographic data, revenue, credit score, popularity, capitalization, current liabilities, licenses, real property, personal property, history of business transactions, corporate structure and industrial sector.

4. The method of claim 1, wherein the interactions between entities comprise an exchange of goods or services, a loan, a contract, a payment, a supply of materials, an extension of credit, a regulatory control, a license, a legal proceeding or combinations thereof.

5. The method of claim 1, wherein the method further comprises using external data in combination with the profile at each entity in the supply chain and each transaction between two entities to determine the current level of vulnerability to perturbations in the supply chain for the plurality of entities in the supply chain.

6. The method of claim 5, wherein the external data comprise meteorological data, economic data, geopolitical data, commodity market data, business market data and demographic trends data.

7. The method of claim 1, wherein the current level of vulnerability to perturbations in the supply chain comprises current cash flow, current creditworthiness, current capital reserves, current market share, current availability of raw materials, current backlog, current ability to meet demand, insufficient insurance, current regulatory constraint or combinations thereof.

8. The method of claim 1, wherein the remedial actions comprise extending credit, making a loan, identifying alternative sources of raw materials, providing access to working capital, identifying investors, increasing insurance, granting a regulatory waiver or combinations thereof.

9. The method of claim 1, wherein the method further comprises enacting the remedial actions in the supply chain.

10. The method of claim 9, wherein the method further comprises updating the profile for at least one entity based on the remedial actions enacted in the supply chain.

11. The method of claim 10, wherein:
the method further comprises identifying a number of levels through the nodes of the graphical representation of the supply chain to receive an updated profile following enacting of remedial actions in the supply chain; and
updating the profiles for all nodes within the number of levels from the at least one entity in the supply chain for which the remedial actions were enacted to reduce the current level of vulnerability.

12. The method of claim 1, wherein the method further comprises filtering the nodes and edges in the graphical representation of the supply chain in accordance with common elements in the profiles.

13. The method of claim 1, wherein the method further comprises:
displaying the graphical representation of the supply chain in a graphical user interface; and
using the graphical user interface to highlight at least one of nodes having common elements in the profiles, nodes having current levels of vulnerability above of predetermined vulnerability level and nodes having current levels of vulnerability within a threshold variance from the predetermined vulnerability level.

14. A computing system for detecting vulnerabilities in a supply chain, the computing system comprising:
a database storing a plurality of entities in the supply chain, a profile for each entity and a plurality of interactions between pairs of entities;
a graph builder in communication with the database to create a graphical representation of the supply chain, the graphical representation comprising a plurality of nodes and a plurality of edges between nodes, each node comprising one of the plurality of entities and each edge comprising one of the plurality of interactions;
a prediction module in communication with the database and the graph builder to determine a current level of vulnerability to perturbations in the supply chain for a plurality of entities in the supply chain using the set of descriptive properties at each entity in the supply chain and each interaction between two entities; and
a recommendation module in communication with the prediction module to identify remedial actions to be taken in the supply chain to reduce the current level of vulnerability for at least one entity in the supply chain.

15. The computing system of claim 14, wherein:
each entity comprises a business, a financial institution, an insurance provider, an aggregate of customers, a vendor, a licensing agency or a regulatory agency;
each profile comprises at least one of geographical location, number of employees, demographic data, revenue, credit score, popularity, capitalization, current liabilities, licenses, real property, personal property, history of business transactions, corporate structure and industrial sector;
the interactions between entities comprise an exchange of goods or services, a loan, a contract, a payment, a supply of materials, an extension of credit, a regulatory control, a license, a legal proceeding or combinations thereof;
the current level of vulnerability to perturbations in the supply chain comprises current cash flow, current creditworthiness, current capital reserves, current market share, current availability of raw materials, current backlog, current ability to meet demand, insufficient insurance, current regulatory constraint or combinations thereof; and
the remedial actions comprise extending credit, making a loan, identifying alternative sources of raw materials, providing access to working capital, identifying investors, increasing insurance, granting a regulatory waiver or combinations thereof.

16. The computing system of claim 14, wherein:
the computing system further comprises an input module in communication with the database to obtain the plurality of entities in the supply chain, the profile for each entity, the plurality of interactions between pairs of entities and external data, the external data comprising meteorological data, economic data, geopolitical data, commodity market data, business market data and demographic trends data; and
the prediction module uses the external data in combination with the profile at each entity in the supply chain and each transaction between two entities to determine the current level of vulnerability to perturbations in the supply chain for the plurality of entities in the supply chain.

17. The computing system of claim 14, wherein the computing system further comprises:
a remediation module to enact the remedial actions in the supply chain; and
a profile updater to update the profile for at least one entity based on the remedial actions enacted in the supply chain.

18. The computing system of claim 14, wherein the computing system further comprises:
an output module to display the graphical representation of the supply chain in a graphical user interface;
a filter to filter the nodes and edges in the graphical representation of the supply chain in accordance with common elements in the profiles; and
a plurality of selectable graphics in the graphical user interface to filter the nodes and edges in accordance with an identified set of common elements and to highlight at least one of nodes having current levels of vulnerability above of predetermined vulnerability level and nodes having current levels of vulnerability within a threshold variance from the predetermined vulnerability level.

19. A computer-readable storage medium containing a computer-readable code that when read by a computer causes the computer to perform a method for detecting vulnerabilities in a supply chain, the method comprising:
creating a graphical representation of the supply chain, the graphical representation comprising a plurality of nodes and a plurality of edges between nodes, each node comprising an entity in the supply chain, each entity comprising a profile and each edge comprising an interaction between two entities;
using the profile at each entity in the supply chain and each interaction between two entities to determine a current level of vulnerability to perturbations in the supply chain for a plurality of entities in the supply chain; and
identifying remedial actions to be taken in the supply chain to reduce the current level of vulnerability for at least one entity in the supply chain.

20. The computer-readable medium of claim 19, wherein the method further comprises:
enacting the remedial actions in the supply chain;
identifying a number of levels through the nodes of the graphical representation of the supply chain to receive an updated profile following enacting of remedial actions in the supply chain; and
updating the profiles for all nodes within the number of levels from the at least one entity in the supply chain for which the remedial actions were enacted to reduce the current level of vulnerability.
